(19) United States
(12) Patent Application Publication
(10) Pub. No.: US 2026/0243356 A1
(43) Pub. Date: Aug. 20, 2026

(54) TUBE CLAMP AND TUBE HOLDER

(71) Applicant: ORGANO CORPORATION, Tokyo (JP)

(72) Inventors: Tadashi SATO, Tokyo (JP); Naoyuki TAJIMA, Tokyo (JP); Takafumi HOSHINO, Nagano (JP)

(73) Assignee: ORGANO CORPORATION, Tokyo (JP)

(21) Appl. No.: 19/153,769

(22) PCT Filed: Jan. 11, 2024
(86) PCT No.: PCT/JP2024/000450

§ 371 Date: Aug. 5, 2025

(30) Foreign Application Priority Data
Feb. 6, 2023 (JP) 2023-016271

(51) Int. Cl. F16K 7/06; F16L 3/10

(52) U.S. Cl. CPC F16K 7/06; F16L 3/10

(57) ABSTRACT

In a tube clamp for retaining a tube for a fluid, one end of a rod-shaped member made of resin is split into a relatively short first pincer piece and a relatively long second pincer piece, with a separation groove formed therebetween, and pinch regions for clamping the tube is set in the separation groove. Retaining grooves that receive the outer periphery of the tube are formed in the pincer pieces the pincer regions. A through-hole is provided in the second pincer piece, and an operation button portion protruding from the first pincer piece passes through the through-hole. By pressing the operation button portion toward the second pincer piece, the separation groove is widened.

### TECHNICAL FIELD The present invention relates to a tube clamp used for retaining a tube (pipe) for a fluid, and a tube holder that is equipped with the tube clamp and holds the tube.

### BACKGROUND ART

There are pure water production devices that enable easy use of pure water and ultrapure water in laboratories, etc., as disclosed in, for example, Patent Literatures 1 and 2. Patent Literatures 1 and 2 also disclose water dispensers (i.e., pure water suppliers) used for pouring pure water produced by these pure water production devices into flasks, beakers, test tubes, and the like. The water dispenser is equipped with a discharge part such as a nozzle and connected to the pure water production device, and discharges pure water from the discharge part in response to an operator's switch operation. When pure water is used in an environment where acids and alkalis are treated, it is necessary to perform the work inside a fume hood. A fume hood is also called a fume chamber or a draft chamber. However, since water dispensers are equipped with solenoid valves, operation panels, electrical circuits, and the like, the water dispensers are not suitable for use in acid or alkali environments, and therefore are not suitable for use inside a fume hood. Then it is attempted to connect one end of a flexible tube to a pure water production device or water dispenser installed outside the fume hood, and draw the tube into the fume hood to discharge pure water from the other end of the tube. A nozzle may be attached to the other end of the tube.

When a tube connected to a pure water production device or water dispenser at one end thereof is drawn into a fume hood, pure water is discharged from the other end of the tube. The other end of the tube must be held at a certain height above the inner bottom plane of the fume hood in order to pour pure water into various instruments such as test tubes, flasks, and beakers, or to use pure water for cleaning these instruments, while preventing contamination of the pure water,. To hold a tube, a device that clamps the tube, i.e., a tube clamp, is required. There are tube clamp that have a slit of fixed width and retain the tube in the slit, but, in such tube clamps, the tube must be deformed and pushed into the slit to fix or adjust the position of the tube, and this operation must be done by hand. Therefore, such tube clamps do not have good operability. Patent Literature 3 discloses a tube clamp including: a base; and a lever attached to the upper surface of the base via a support rod, wherein a groove for placing a tube is formed on the upper surface of the base, so that by rotating the lever, the tube is clamped between the lever and the groove.

### CITATION LIST

### Patent Literatures

Patent Literature 1: JP 2020-81942 A

Patent Literature 2: JP 2020-81945 A

Patent Literature 3: JP 2019-206997 A

### SUMMARY OF INVENTION

### Technical Problem

Since the tube clamp disclosed in Patent Literature 3 requires the base and the lever that are prepared as separate components and assembled so that the lever can rotate, and also requires incorporation of a ball plunger or the like to prevent unintended rotation of the lever, the tube clamps has a problem of complex configuration.

The object of the present invention is to provide a tube clamp that is simple in configuration and easy to operate, and a tube holder that equipped with such a tube clamp and holds a tube.

### Solution to Problem

The tube clamp according to the present invention is a tube clamp which is used to retain a tube for a fluid and includes: a rod-shaped member made of resin; and an operation button portion, wherein one end of the rod-shaped member is split into a first pincer piece and a second pincer piece to form a separation groove between the first pincer piece and the second pincer piece, and a length of the second pincer piece in a longitudinal direction of the rod-shaped member is longer than that of the first pincer piece, wherein a pinch region for clamping the tube is set in the separation groove, a retaining groove is formed in at least one of the first pincer piece and the second pincer piece in the pinch region to receive an outer periphery of the tube, and the tube can be clamped by the first pincer piece and the second pincer piece in the pinch region, wherein a through-hole is provided in the second pincer piece, wherein the operation button portion is provided at a tip part of the first pincer piece so that the operation button portion protrudes from the first pincer piece toward the second pincer piece and further protrudes from the outer periphery of the rod-shaped member through the through-hole, and wherein s distance between the first pincer piece and the second pincer piece is widened by pressing a top surface of the operation button portion toward the second pincer piece.

The tube holder according to the present invention includes: the tube clamp according to the present invention; and a support member, wherein the support member includes a mounting hole into which a mounting portion formed on the other end of the rod-shaped member can be fit, and wherein the tube clamp is detachably secured to the support member by fitting the mounting portion into the mounting hole.

### Advantageous Effects of Invention

According to the present invention, it is possible to provide a tube clamp that is simple in configuration and easy to operate, and a tube holder that holds a tube with such a tube clamp.

### BRIEF DESCRIPTION OF DRAWING

FIG. 1A is a perspective view illustrating a tube clamp according to an embodiment of the present invention;

FIG. 1B is a front view illustrating the tube clamp;

FIG. 1C is a bottom view illustrating the tube clamp;

FIG. 1D is an enlarged perspective view illustrating the clamping portion of the tube clamp;

FIG. 1E is an enlarged perspective view illustrating the mounting portion of the tube clamp;

FIG. 2 is a perspective view schematically illustrating the operation of attaching a tube to the tube clamp;

FIG. 3A is a perspective view illustrating a holding stand;

FIG. 3B is an enlarged perspective view illustrating the mounting hole of the holding stand;

FIG. 3C is a view schematically illustrating the shape of the fitting part of the holding stand:

FIG. 3D is an enlarged perspective view illustrating the mounting configuration of the tube clamp on the holding stand;

FIG. 3E is a perspective view illustrating the retention of a tube by the tube clamp attached to the holding stand; and

FIG. 4 is a diagram illustrating an example of the application of the tube clamp.

### DESCRIPTION OF EMBODIMENTS

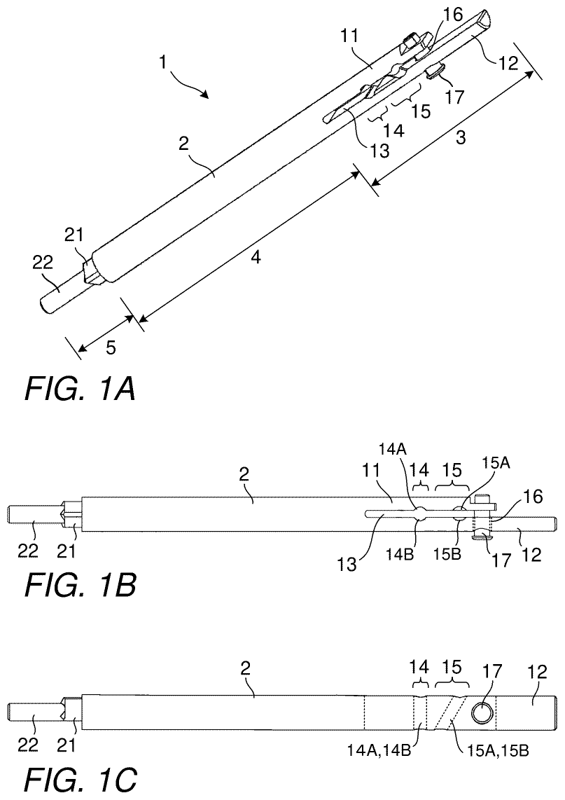

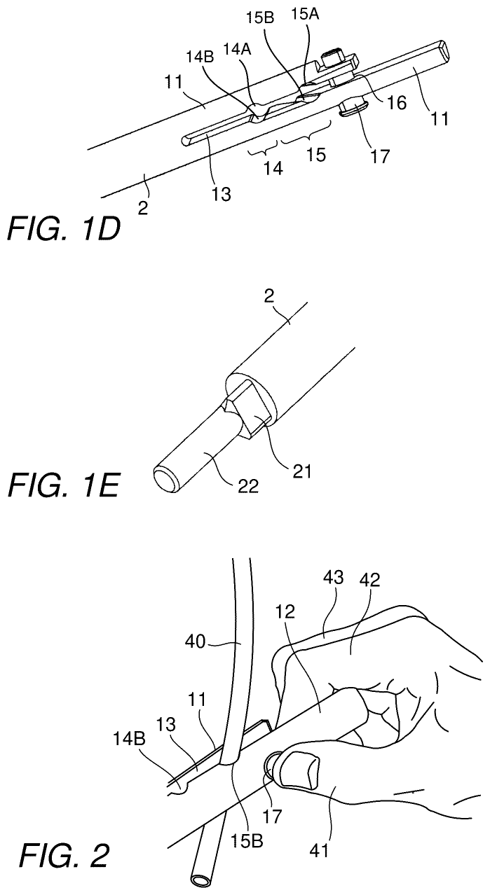

The preferred embodiments of the present invention will be described with reference to the drawings. FIGS. 1A to 1E show tube clamp 1 according to an embodiment of the present invention, and, in particular, FIGS. 1A, 1B and 1C are a perspective, front and bottom view of tube clamp 1, respectively. FIGS. 1D and 1C show clamping portion 3 and mounting portion 5 of tube clamp 1, respectively, in an enlarged manner.

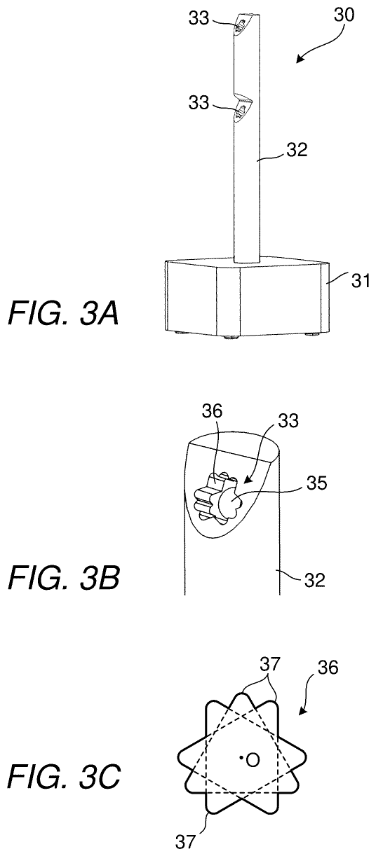

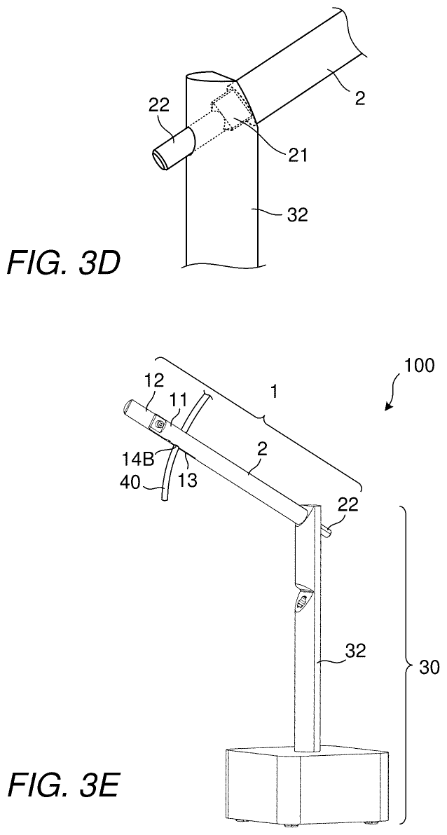

Tube clamp 1 shown in FIGS. 1A to 1E is used to retain clamp tube 40 (see FIGS. 3 and 3E) used to feed a fluid by pinching tube 40. Tube 40 pinched by tube clamp 1 is made of a flexible resin, for example. The type of fluid fed by tube 40 is not particularly limited and may be any liquid or any gas. When the fluid is pure water or ultrapure water, tube 40 is made of, for example, PFA (perfluoroalkoxyalkane) resin or polyolefin to prevent contamination.

Tube clamp 1 is equipped with rod-shaped member 2 made of resin. The shape of the transverse section of rod-shaped member 2 is not particularly limited, but is, for example, circular or hexagonal. Here, the transverse section is the cross-section perpendicular to the longitudinal direction of rod-shaped member 2. In the example shown in FIGS. 1A to 1E, the transverse section of rod-shaped member 2 is circular, and rod-shaped member 2 is a round bar as a whole. Rod-shaped member 2 is divided along its longitudinal direction into three sections: clamping portion 3, intermediate portion 4, and mounting portion 5. One end side of rod-shaped member 2 is clamping portion 3 and the other end side is mounting portion 5, and intermediate portion 4 is between clamping portion 3 and mounting portion 5.

In clamping portion 3, which is the one end of rod-shaped member 2, rod-shaped member 2 is split into first pincer piece 11 and second pincer piece 12, as if rod-shaped member 2 were cut lengthwise in a plane parallel to the longitudinal direction of rod-shaped member 2. Separation groove 13 is formed between first pincer piece 11 and second pincer piece 12. Both first pincer piece 11and second pincer piece 12 are semi-circular in transverse section. Both first pincer piece 11 and second pincer piece 12 extend in the longitudinal direction of rod-shaped member 2, for example in a tongue or bar shape, but second pincer piece 12 is longer than first pincer piece 11 with regard to the length of extending along the longitudinal direction of rod-shaped member 2 toward the one end of rod-shaped member 2. First pincer piece 11 and second pincer piece 12 face each other through separation groove 13, and the surfaces facing each other through separation groove 13 in pincer piece 11, 12 are flat. The distance between first pincer piece 11 and second pincer piece 12 facing each other through separation groove 13, i.e., the width of separation groove 13, is narrower than the outer shape of tube 40 that this tube clamp 1 is intended to retain. The curved surface in each pincer piece 11, 12 is a part of the outer periphery of rod-shaped member 2.

In separation groove 13, a pinch region is set, which is the location where tube 40 is clamped. In the illustrated example, two pinch regions 14, 15 are settled. In pinch region 14, at least one of first pincer piece 11 and second pincer piece 12 facing each other has retaining groove for receiving the outer periphery of tube 40 to be clamped. In the illustration, retaining grooves 14A, 14B are formed on first pincer piece 11 and second pincer piece 12, respectively. Retaining grooves 14A, 14B face each other and extend in a direction perpendicular to the longitudinal direction of rod-shaped member 2, with the both ends reaching the outer periphery of rod-shaped member 2, respectively. Similarly, in pinch region 15, retaining grooves 15A, 15B are formed on first pincer piece 11 and second pincer piece 12, respectively, so as to reach the outer periphery of rod-shaped member 2. In pinch region 15, however, the direction in which retaining grooves 15A, 15B extend is a direction that forms an angle of about 60°with the longitudinal direction of rod-shaped member 2. By differing the direction of extension of the retaining grooves in pinch regions 14, 15 in this manner, it is possible to pinch tube 40 at different angles when clamping it.

Second pincer piece 12 is provided with through-hole 16 at a position facing the tip part of first pincer piece 11. Operation button portion 17 penetrating through-hole 16 is attached to the tip part of first pincer piece 11. That is, operation button portion 17 protrudes from first pincer piece 11 toward second pincer piece 12 and further protrudes from the outer periphery of rod-shaped member 2 through through-hole 16. Operation button portion 17 can smoothly move in through-hole 16 with respect to second pincer piece 12. As a result, by pressing pushbutton portion 17 toward second pincer piece 12 so as to push the top surface of operation button portion 17, first pincer piece 11 is elastically displaced in the direction away from second pincer piece 12, and the distance between first pincer piece 11 and second pincer piece 12 widens. In this state, separation groove 13 is widened at the position of pinch regions 14, 15, and tube 40 can be inserted into separation groove 13 without resistance. After that, if the pressure on operation button portion 17 is stopped, first pincer piece 11 returns to its original position and the width of separation groove 13 returns to its original width, and tube 40 that has already been inserted is pinched by first pincer piece 11 and second pincer piece 12, with its outer periphery secured by retaining grooves 14A, 14B (or retaining grooves 15A, 15B). Tube 40 for fluid is thus clamped and retained by tube clamp 1.

Similarly, when removing already clamped tube 40 from tube clamp 1, operation button portion 17 is simply pressed to widen separation groove 13, and in this state, tube 40 can be easily pulled out of separation groove 13. Tube clamp 1 according to the present embodiment does not use a spring made of, for example, metal or the like, but uses the elastic force of the resin constituting rod-shaped member 2 to detachably clamp tube 40.

FIG. 2 schematically illustrates the operation for clamping tube 40 in tube clamp 1. In the example shown in FIG. 2, the user is manipulating tube clamp 1 with his/her right hand. The user picks and holds tube clamp 1 by bringing index finger 42 into contact with the surface of second pincer piece 12 on the side of separation groove 13 at a portion where second pincer piece 12 protrudes from first pincer piece 11, and covering operation button portion 17 with thumb 41. In this state, if the user presses operation button portion 17 with his/her thumb 41, the distance between first pincer piece 11 and second pincer piece 12 widens and separation groove 13 opens, allowing the user to hold tube 40 with his/her left hand (not shown) and slide tube 40 into separation groove 13. Thereafter, tube 40 is clamped in tube clamp 1 as described above when the pressure of operation button portion 17 is stopped. FIG. 2 also depicts middle finger 43, which is attached to index finger 42. In tube clamp 1 shown in FIG. 2, only second pincer piece 12 has retaining grooves 14B, 15B in pinch regions 14, 15, and first pincer piece 11 has no retaining grooves. Even if only one of the pincer pieces is provided with a retaining groove in this manner, tube 40 can be stably clamped by tube clamp 1.

Next, mounting portion 5 will be described. In order to place tube 40 at the desired position, it is not enough to simply retain tube 40 in clamping portion 3 of rod-shaped tube clamp 1, but tube clamp 1 itself must be held by attaching tube clamp 1 to some object, such as a holding stand, for example. A member which is provided on the holding stand or other object and to which tube clamp 1 is actually attached and secured is called support member 32 (see FIG. 3A). Mounting portion 5 of tube clamp 1 is used to attach tube clamp 1 to support member 32 and is a portion which is inserted into mounting hole 33 (see FIG. 3A) provided in support member 32.

In the present embodiment, mounting portion 5 is constituted by polygonal column portion 21 formed into a polygonal column adjacent to intermediate portion 4, and cylindrical portion 22 protruding from polygonal column portion 21 toward the tip of the other end of rod-shaped member 2. Polygonal column portion 21 is composed of a regular polygonal column having a regular polygonal base, for example, and functions to fit into fitting part 36 (see FIG. 3B) formed on the inner wall of mounting hole 33 to secure tube clamp 1 to support member 32 with a predetermined posture. In the illustrated example, polygonal column portion 21 is composed of an equilateral triangular prism. Although it is possible to configure polygonal column portion 21 by a quadrangle prism with a square base, it is preferable to configure polygonal column portion 21 with an equilateral triangular prism from the viewpoint of ease of processing on mounting hole 33, especially when forming fitting part 36 of mounting hole 33 as a star-shaped polygonal recess as described below. Cylindrical portion 22 is provided to guide the insertion direction when inserting tube clamp 1 into mounting hole 33. Therefore, the radius of cylindrical portion 22 should be less than or equal to the radius of the circle inscribed in the regular polygon that constitutes the bottom surface of polygonal column portion 21. In terms of length along the longitudinal direction of tube clamp 1, cylindrical portion 22 is sufficiently longer than polygonal column portion 21. To facilitate insertion of mounting portion 5 toward mounting hole 33, as shown in the figures, it is preferable to apply chamfering processing to the portion that is a corner or ridge in polygonal column portion 21 and cylindrical portion 22.

In tube clamp 1 according to the present embodiment, there is no particular limitation on the resin that constitutes rod-shaped member 2, and various resins with moderate elasticity can be used. For example, polypropylene (PP), acrylic resin (especially polymethyl methacrylate (PMMA)), polyvinyl chloride (PVC), high-density polyethylene (HD-PE), polycarbonate (PC), polyacetal (POM), ABS resin (acrylonitrile-butadiene-styrene copolymer resin), polyvinylidene fluoride (PVDF), polytetrafluoroethylene (PTFE), polystyrene (PS), and the like can be used.

However, if tube clamp 1 is to be used in a corrosive environment or an environment where organic solvents are present, it is necessary to select a resin that can withstand those environments as the resin that constitutes rod-shaped member 2. Since separation groove 13 is widened by pressing operation button portion 17 in tube clamp 1 according to the present embodiment, tube clamp 1 is easy-to-use if the force required when pressing is small. From this perspective, it is preferable to use a relatively flexible resin. On the other hand, if a resin that is too flexible is used, the force to clamp the tube becomes small, and the tube may unintentionally fall out of tube clamp 1. Considering these points, low-density polyethylene (LD-PE) is somewhat too soft, and polyether ether ketone (PEEK) and polyphenylene sulfide (PPS) are somewhat too hard. Polypropylene, which is easy to obtain and process and low cost, is the most preferred resin for constituting rod-shaped member 2.

In the present embodiment, rod-shaped member 2, including clamping portion 3 and mounting portion 5, can be formed by injection molding of resin. Alternatively, a round or square bar of a predetermined length made of resin may be prepared, and clamping portion 3 and mounting portion 5 may be formed into rod-shaped member 2 by cutting these bars. When processing rod-shaped member 2 by cutting, first pincer piece 11 and second pincer piece 12 are also formed simultaneously by cutting the round or square bar along its longitudinal direction from one end of the round or square bar to form separation groove 13. Thereafter, through-hole 16 is formed in second pincer piece 12 and first pincer piece 11 is cut to a predetermined length to complete clamping portion 3.

In the present embodiment, operation button portion 17 can also be formed of resin, but operation button portion 17 can also be constructed of rubber or other materials. Operation button portion 17 can be attached to first pincer piece 11 by screw fastening, fixing with adhesive, fixing by heat welding, or other methods. Rod-shaped member 2 and operation button portion 17 can be constructed as a single piece, or can be molded as a single piece by resin.

The outer diameter of tube clamp 1 is selected according to the outer diameter of tube 40 to be clamped. When rod-shaped member 2 has a shape of a round bar, the outer diameter of tube clamp 1 is expressed as a diameter as a round bar. When the outer diameter of tube 40 is between 4 mm and 8 mm, the outer diameter of tube clamp 1 is preferably between 10 mm and 30 mm. When the outer diameter of tube 40 is between 10 mm and 16 mm, the outer diameter of tube clamp 1 is preferably between 25 mm and 35 mm.

Tube clamp 1 is usually used attached to some object. Assuming that tube clamp 1 is used attached to a holding stand, the holding stand is described below. The assembly consisting of the holding stand and tube clamp 1 attached to the holding stand is called a tube holder. FIGS. 3A to 3E show an example of a configuration of holding stand 30 used to hold tube clamp 1 shown in FIGS. 1A to 1E. In particular, FIG. 3A is a perspective view of holding stand 30, FIG. 3B is an enlarged perspective view of mounting hole 33 of holding stand 30, and FIG. 3C is a view schematically showing the shape of fitting part 36 of holding stand 30. FIG. 3D is an enlarged perspective view showing the mounting configuration of tube clamp 1, and FIG. 3E is a perspective view illustrating the retention of tube 40 by tube clamp 1 mounted on holding stand 30.

Holding stand 30 consists of pedestal 31 and rod-shaped support member 32 that stands upright from pedestal 31. Support member 32 is provided with mounting hole 33 into which mounting portion 5 of tube clamp 1 is removably inserted. When pouring pure water into a container (e.g., a beaker or a measuring cylinder) by discharging pure water from the tip of tube 40, there is a demand to change the height of the position at which pure water is discharged from tube 40 because the height of the container varies with the type of container. Therefore, it is desirable to provide multiple mounting holes 33 in support member 32 so that the mounting position of tube clamp 1 can be changed. In holding stand 30 shown in the figure, two mounting holes 33 are provided, one in the middle of support member 32 in the longitudinal direction thereof and the other at the tip end of support member 32.

As shown in FIG. 3B, mounting holes 33 are formed in support member 32 so as to penetrate support member 32. To prevent mounted tube clamp 1 from unintentionally falling out of mounting hole 33, mounting hole 33 obliquely penetrates support member 32, and tube clamp 1 is mounted in mounting hole 33 via mounting portion 5 so that the position of clamping portion 3 is higher than that of mounting portion 5. In other words, with mounting portion 5 fitted into mounting hole 33, tube clamp 1 extends diagonally upward from mounting hole 33.

At this time, the angle between the horizontal plane and the longitudinal direction of tube clamp 1 is preferably between 5° and 45°, more preferably between 25° and 35°, and even more preferably 30°.

Mounting hole 33 consists of fitting part 36 into which the outer periphery of the polygonal column portion 21 of tube clamp 1 fits and through-hole 35 that is continuous from fitting part 36. Fitting part 36 is located on the inlet side in the insertion direction of tube clamp 1 compared to through-hole 35, and is provided with a concave shape corresponding to polygonal column portion 21. By fitting polygonal column portion 21 into fitting part 36, tube clamp 1 can be secured to support member 32. In the example shown here, polygonal column portion 21 of tube clamp 1 is an equilateral triangular prism, so fitting part 36 need only be formed as a recess into which the equilateral triangular prism can fit, for example, it can be formed as an equilateral triangular recess. However, when holding tube 40 by tube clamp 1, there is a desire to adjust the angle between the direction of extension of tube 40 being clamped and the horizontal plane by rotating tube clamp 1 around a central axis extending in the longitudinal direction of tube clamp 1. To satisfy such a desire, fitting part 36 can be formed as a star-shaped polygonal recess. If rod-shaped member 2 is in the form of a round bar or a regular polygonal prism, the central axis as a round bar or a regular polygonal prism is the central axis of tube clamp 1.

FIG. 3C is a view showing the shape of fitting part 36 when mounting hole 33 shown in FIG. 3B is viewed from its front side. In FIG. 3C, point O shows the position corresponding to the central axis of tube clamp 1. Illustrated fitting part 36 is formed as a star-shaped polygonal recess with nine vertices 37 whose internal angle is less than 180°. Specifically, fitting part 36 has the shape of a star polygon resulting from superposition of an equilateral triangle corresponding to polygonal column portion 21 of tube clamp 1 and two equilateral triangles obtained by rotating such an equilateral triangle by +30° and −30° around point O, respectively. Such fitting part 36 allows the posture of tube clamp 1 to be defined at angles of 30° increments around the central axis of tube clamp 1, allowing adjustment of the angle between the direction of extension of clamped tube 40 and the horizontal plane. Assuming that N is an integer greater than or equal to 3, if polygonal column portion 21 is composed of a regular N-gonal prism, fitting part 36 may be formed as a regular N-gon recess, or as a star polygon having k×N vertices whose internal angle is less than 180°, assuming that k is an integer of 2 or more.

Because cylindrical portion 22 is sufficiently longer than poly gonal column portion 21 in length in the longitudinal direction of tube clamp 1, in the example shown here as shown in FIG. 3D, with polygonal column portion 21 of tube clamp 1 fitting into fitting parr 36, cylindrical portion 22 of tube clamp 1 passes through through-hole 35 and protrudes from support member 32. When attaching tube clamp 1 to mounting hole 33, accurate alignment of poly gonal column portion 21 and fitting part 36 is necessary, but by providing such through-hole 35, cylindrical portion 22 first enters through-hole 35 before polygonal column portion 21 reaches the position of fitting part 36, thereby regulating the movement direction of tube clamp 1. This makes it easier to align polygonal column portion 21 with fitting part 36. When changing the posture of tube clamp 1 by rotating it around the central axis, since tube clamp 1 can be rotated while cylindrical portion 22 remains in through-hole 35 even after polygonal column portion 21 is separated from fitting part 36, tube clamp 1 need not be pulled out completely from mounting hole 33. The operation for changing the posture is also facilitated.

FIG. 3E shows an example of a state in which tube clamp 1 already clamping tube 40 is attached to holding stand 30. Tube holder 100 consisting of tube clamp 1 and holding stand 30 may be used in a corrosive environment, for example, in a fume hood. It is necessary to suppress the generation of fine powder, e.g., metal powder, when attaching or removing tube clamp 1 to or from support member 32. Therefore, it is preferable that support member 32 is made of resin. The same resin as that used for tube clamp 1 can be used for support member 32. To prevent holding stand 30 from wobbling, pedestal 31 must have a certain amount of mass, and the use of metal is effective to increase the mass. However, in order to prevent corrosion or the like, even if pedestal 31 is made of metal, it is preferable that at least the surface of pedestal 31 is made of resin so that no metal portions are exposed.

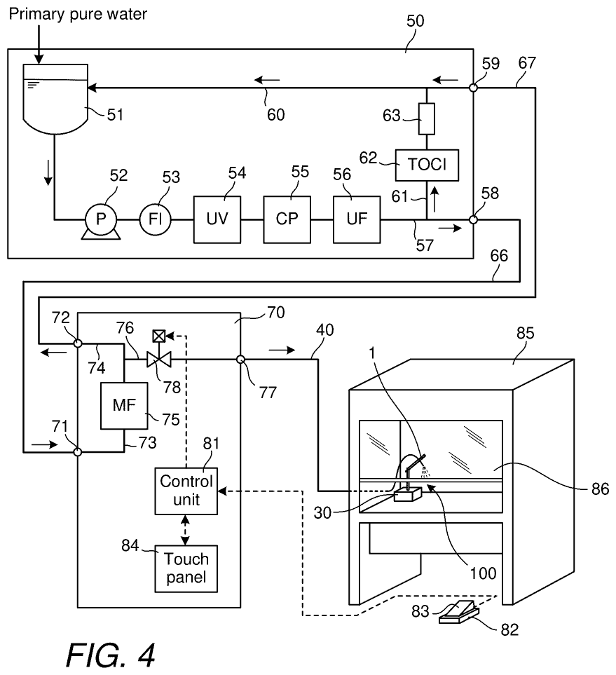

Next, an example of a use form of the tube holder described above, consisting of tube clamp 1 and holding stand 30, is described using FIG. 4. Here, the use form of the tube holder will be explained using the case of supplying pure water to a point of use via tube 40, as an example.

To supply pure water to the point of use, provided are pure water production device 50 that produces pure water, and pure water supplier 70 that is connected to pure water production device 50 and receives the supply of pure water from pure water production device 50. Pure water supplier 70, also called a water dispenser, is located in close proximity to the point of use, but pure water production device 50 may be located away from the point of use because it can be a large-scaled device. In the following, described as an example for explanation is a case in which fume hood 85 installed in a laboratory or analysis room configured as a clean room is taken as a point of use and pure water is supplied into fume hood 85 from pure water supplier 70 in response to a user's request. Fume hood 85 is installed to treat corrosive chemicals such as nitric acid and hydrochloric acid, for example, and the interior of fume hood 85 is a corrosive environment.

Pure water production device 50 is configured as a subsystem (also called a secondary pure water system) that produces pure water through circulation purification, and equipped with: storage tank 51 to which primary pure water is supplied; pump 52 connected to the outlet of storage tank 51 to feed pure water stored in storage tank 51; flow sensor (FI) 53 connected to the outlet of pump 52; ultraviolet oxidation device (UV) 54; a non-regenerative ion exchange device (CP: also called a cartridge polisher) 55 filled with strongly acidic cation exchange resin and strongly basic anion exchange resin in a mixed bed manner; and ultrafiltration device (UF) 56. Ultraviolet oxidization device 54, non-regenerative ion exchange device 55, and ultrafiltration device 56 are connected in this order in series to the outlet of flow sensor 53. Ultraviolet oxidation device 54 is provided to decompose total organic carbon (TOC) components in pure water. Pipe 57 is connected to the outlet of ultrafiltration device 56, and pipe 61 branches off from pipe 57. Pipe 61 is connected to TOC meter (TOCI) 62 that measures the TOC concentration of the outlet water of ultrafiltration device 56. Constant flow valve 63 for making an inflow amount to TOC meter 62 constant is connected to the secondary side of TOC meter 62, and the outlet of constant flow valve 63 joins pipe 60 that returns to storage tank 51. Pure water production device 50 can be installed outside the clean room.

Pure water production unit 50 produces pure water through circulation purification, and in the example shown here, the pure water is circulated including pure water supplier 70. Therefore, the outlet of ultrafiltration device 56 is connected to circulation outlet 58 of pure water production device 50 via pipe 57. Pure water production device 50 is also equipped with circulation inlet 59 that receives pure water returned from pure water supplier 70, and circulation inlet 59 is connected to storage tank 51 via pipe 60. As the primary pure water, for example, water obtained by passing city water through a filter, an activated carbon treatment unit, and an ion exchange unit is used.

In this pure water production device 50, configured is a circulating purification system that passes from storage tank 51 through pump 52, flow sensor 53, ultraviolet oxidation device 54, non-regenerative ion exchange device 55, ultrafiltration device 56, and pure water supplier 70, and returns to storage tank 51. Pure water is further purified by operating pump 52 to circulate pure water through the circulation purification system.

Pure water supplier 70 is connected to pure water production device 50 by pipes 66, 67. Pipe 66 connects circulation outlet 58 of pure water production device 50 to circulation inlet 71 of pure water supplier 70, and pipe 67 connects circulation inlet 69 of pure water production device 10 to circulation outlet 72 of pure water supplier 70. In pure water supplier 70, provided as a filter cartridge is microfiltration device (MF) 75 which is equipped with a microfiltration membrane with a pore diameter of, for example, 20 to 50 nm to remove particulates just before the point of use of pure water. Microfiltration device 75 also constitutes a part of the circulation purification system described above. Pure water is supplied to microfiltration device 75 from circulation inlet 71 via pipe 73, and the pure water that has passed through microfiltration device 75 is returned to pure water production device 50 from pipe 74 via circulation outlet 72.

The microfiltration membrane in microfiltration membrane device 75, for example, uses polyethylene modified by sulfonic acid groups as a base material and has an ion adsorption function. By having an ion adsorption function, the microfiltration membrane can remove very small amounts of particulates and metal ions generated in the piping and fittings between pure water production device 50 and pure water supplier 70, enabling higher quality pure water to be provided to users at the point of use. In addition, at pure water supplier 70, pipe 76 branches off from pipe 74 to supply the pure water that has passed through microfiltration membrane device 75 to the point of use, and pipe 76 connects to pure water outlet 77 of pure water supplier 70. In pipe 76, proportional control valve 78, which is a solenoid valve, is provided to control the supply of pure water to the point of use.

Fume hood 85, a point of use, is equipped with glass window 86 that can be opened and closed in front of it. Pure water supplier 70 is located in the clean room and in proximity to fume hood 85, and tube 40 connected to pure water outlet 77 of pure water supplier 70 is drawn into fume hood 85. In fume hood 85, pure water is discharged from the tip of tube 40. To adjust the position at which pure water is discharged from tube 40, tube holder 100 described above is installed in fume hood 85, and tube 40 is clamped in tube clamp 1 of tube holder 100.

Control unit 81 that controls the opening degree of proportional control valve 78 to control the flow rate of pure water discharged from the tip of tube 40 is provided in pure water supplier 70, and foot controller 82 that is operated by the user's foot is connected to control unit 81. Foot controller 82 generates a signal indicating an operation amount corresponding to the amount of operation by the user's foot and transmits this signal to control unit 81. In the illustrated example, foot controller 82 is equipped with pedal 83 biased upwardly by a spring (not shown) or the like, and is configured so that, when the user depresses pedal 83, it transmits the signal to control unit 81 in accordance with the amount of depressing. Pure water supplier 70 is also provided with touch panel 84 as an operation panel for presenting necessary information to the user and accepting input from the user. Touch panel 84 is connected to control unit 81.

Next, the use of pure water in fume hood 85, which is a point of use, will be described. Foot controller 82 generates and transmits a signal to control unit 81 according to the amount of depression of its pedal 83, and control unit 81 controls the proportional control valve 78 so that, for example, the opening degree of the valve corresponds to the amount of depression of pedal 83. As a result, pure water is supplied to tube 40 via proportional control valve 78 and discharged from the tip of tube 40, only when the user depresses pedal 83 of foot controller 82. In other words, pure water is discharged when the user needs it. Tube 40 is clamped in tube holder 100, and by which orientation tube clamp 1 is attached to which mounting hole 33 of support member 32 and by which pinch region 14, 15 of tube clamp 1 is used to pinch tube 40, the user can set the height and orientation of the tip of tube 40 in fume hood 85 to the desired height and orientation to discharge pure water from the tip of tube 40. To change the height of the tip of tube 40 significantly, mounting hole 33 where tube clamp 1 is attached in support member 38 can be changed. Fine adjustment of the height can be performed by widening separation groove 13 by operating operation button portion 17 on tube clamp 1 and sliding tube 40 in that state to change the length from pinch region 14, 15 to the tip of tube 40.

In the example shown in FIG. 4, pure water is supplied to fume hood 85 by drawing tube 40 into fume hood 85 from pure water supplier 70, which is located outside fume hood 85. This prevents generation of corrosion of the solenoid valves and electronic circuits in pure water supplier 70 due to acids and other chemicals handled in fume hood 85. Tube holder 100, consisting of tube clamp 1 and holding stand 30, is installed in fume hood 85, but tube clamp 1 is made of resin and contains no metal, and holding stand 30 also contains no exposed metal, so generation of corrosion in tube holder 100 is suppressed and contamination inside fume hood 85 due to the corrosive products is also prevented. Therefore, tube clamp 1 and the tube holder according to the present invention are particularly useful in clean rooms and when handling corrosive substances.

### REFERENCE SIGNS LIST

1 Tube clamp;
2 Rod-shaped member;
3 Clamping portion;
5 Mounting portion;
11, 12 Pincer piece;
13 Separation groove;
14, 15 Pinch region;
14A, 14B, 15A, 15B Retaining groove;
16, 35 Through-hole;
17 Operation button portion;
21 Polygonal portion;
22 Cylindrical portion;
30 Holding stand;
31 Pedestal;
32 Supporting column;
33 Mounting hole;
36 Fitting part;
40 Tube;
50 Pure water production device;
85 Fume hood; and
100 Tube holder.

1. A tube clamp used to retain a tube for a fluid, comprising:
a rod-shaped member made of resin; and
an operation button portion,
wherein one end of the rod-shaped member is split into a first pincer piece and a second pincer piece to form a separation groove between the first pincer piece and the second pincer piece, and a length of the second pincer piece in a longitudinal direction of the rod-shaped member is longer than that of the first pincer piece,
wherein a pinch region for clamping the tube is set in the separation groove, a retaining groove is formed in at least one of the first pincer piece and the second pincer piece in the pinch region to receive an outer periphery of the tube, and the tube can be clamped by the first pincer piece and the second pincer piece in the pinch region,
wherein a through-hole is provided in the second pincer piece,
wherein the operation button portion is provided at a tip part of the first pincer piece so that the operation button portion protrudes from the first pincer piece toward the second pincer piece and further protrudes from the outer periphery of the rod-shaped member through the through-hole, and
wherein s distance between the first pincer piece and the second pincer piece is widened by pressing a top surface of the operation button portion toward the second pincer piece.

2. The tube clamp according to claim 1, wherein a plurality of the pinch regions are set in the separating groove, and an extending direction of the retaining groove is different for each pinch region.

3. The tube clamp according to claim 1, wherein the operation button portion is provided as an integral part of the rod-shaped member.

4. A tube holder comprising:
the tube clamp according to claim 1; and
a support member,
wherein the support member includes a mounting hole into which a mounting portion formed on the other end of the rod-shaped member can fit, and
wherein the tube clamp is detachably secured to the support member by fitting the mounting portion into the mounting hole.

5. The tube holder according to claim 4, wherein the mounting portion includes a polygonal column portion formed into a polygonal column, and the mounting hole includes a fitting part into which the polygonal column portion can fitted.

6. The tube holder according to claim 5, wherein, assuming that N is an integer greater than or equal to 3 and k is an integer greater than or equal to 2, the polygonal column is a regular N-gonal prism, and the fitting part is formed as a star-shaped polygonal recess having k×N vertices whose internal angle is less than 180°, and the mounting portion can be fitted into the mounting hole at different rotation angles around a central axis of the tube clamp.

7. The tube holder according to claim 5,
wherein the mounting portion is further provided with a cylindrical portion on a tip side of the other end of the rod-shaped member than the polygonal column portion, and
wherein the mounting hole is further provided with a through-hole that is connected to the fitting part and can receive the cylindrical portion.

8. The tube holder according to claim 5, further comprising a pedestal, the support member being formed in a shape of a rod and provided upright against the pedestal.

9. The tube holder according to claim 8, wherein the mounting hole is arranged at each of a plurality of locations along a longitudinal direction of the support member.

10. The tube holder according to claim 9, wherein the tube clamp extends diagonally upward from the mounting hole such that the mounting portion is located at a lower position than the one end of the rod-shaped member when the mounting portion is fitted into the mounting hole.

11. The tube clamp according to claim 2, wherein the operation button portion is provided as an integral part of the rod-shaped member.

12. The tube holder according to claim 6,
wherein the mounting portion is further provided with a cylindrical portion on a tip side of the other end of the rod-shaped member than the polygonal column portion, and
wherein the mounting hole is further provided with a through-hole that is connected to the fitting part and can receive the cylindrical portion.
